(19) United States
(12) Patent Application Publication
(10) Pub. No.: US 2017/0322717 A1
(43) Pub. Date: Nov. 9, 2017

(54) METHOD OF SELECTIVE DISPLAY OF VEHICLE INFORMATION

(71) Applicant: Mitac International Corp., Taoyuan City (TW)

(72) Inventors: Ying-Tz Cheng, Taoyuan City (TW); Yen-Cheng Wu, Taoyuan City (TW)

(73) Assignee: Mitac International Corp., Taoyuan City (TW)

(21) Appl. No.: 15/587,057

(22) Filed: May 4, 2017

(30) Foreign Application Priority Data
May 6, 2016 (TW) 105114075

(51) Int. Cl. G06F 3/0484; G06F 3/16

(52) U.S. Cl. CPC G06F 3/04847; G06F 3/167

(57) ABSTRACT

A method of selective display of vehicle information is to be implemented by an electronic system, and includes steps of: a) obtaining, by a processing unit of the electronic system, measured data of a physical quantity that is associated with a vehicle as generated by a sensing unit of the electronic system; b) making a determination, by the processing unit, as to whether the measured data satisfies a predefined criteria; c) controlling, by the processing unit when a result of the determination is affirmative, an output unit of the electronic system to display the measured data; and d) controlling, by the processing unit when the result of the determination is negative, the output unit to refrain from displaying the measured data.

### CROSS-REFERENCE TO RELATED APPLICATION

This application claims priority of Taiwanese Patent Application No. 105114075, filed on May 6, 2016.

### FIELD

The disclosure relates to a method of selective display, and more particularly to a method of selective display of vehicle information.

### BACKGROUND

Smartphones have been used as a head-up display (HUD) for providing information to a driver of a vehicle. The information is displayed on a display of the smartphone in a way of mirror writing, so that when the display is disposed to face a windshield of the vehicle, the information reflected by the windshield would appear in a natural way.

However, the size of the smartphone imposes a limitation on the amount of information that can be displayed, and if an extensive amount of information is fitted in a small screen, overcrowdedness of the arranged information may hinder recognition of the information.

### SUMMARY

Therefore, an object of the disclosure is to provide a method of selective display of vehicle information that can alleviate at least one of the drawbacks of the prior art.

According to the disclosure, the method is to be implemented by an electronic system that is disposed on a vehicle and that includes a sensing unit, an output unit and a processing unit. The sensing unit detects a physical quantity associated with the vehicle and generates a measured data according to a result of detection of the physical quantity. The method includes the following steps:

a) obtaining, by the processing unit, the measured data generated by the sensing unit;

b) making a determination, by the processing unit, as to whether the measured data satisfies a predefined criteria;

c) controlling, by the processing unit when a result of the determination is affirmative, the output unit to display the measured data; and

d) controlling, by the processing unit when the result of the determination is negative, the output unit to refrain from displaying the measured data.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating an embodiment of an electronic system that is used to implement a method of selective display of vehicle information according to the disclosure; and

FIG. 2 is a flow diagram illustrating an embodiment of the method of selective display of vehicle information according to the disclosure.

### DETAILED DESCRIPTION

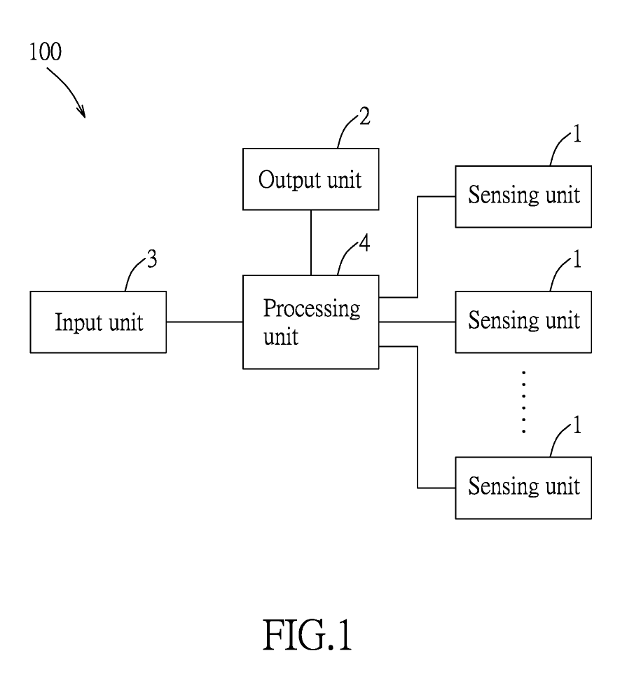

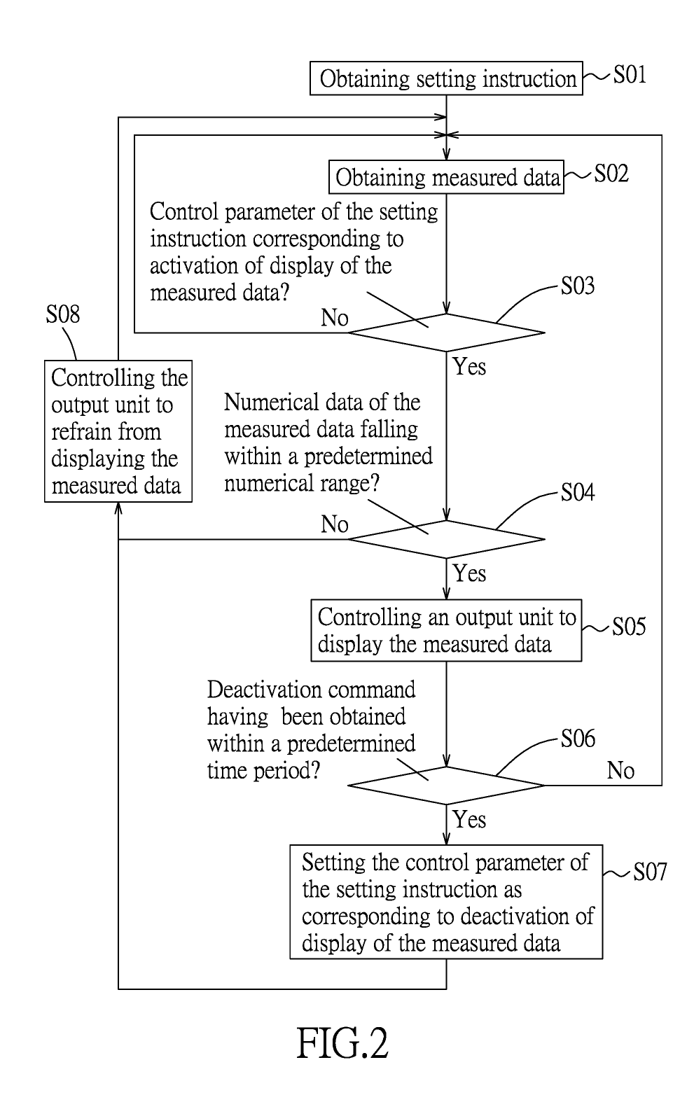

Referring to FIGS. 1 and 2, an embodiment of a method of selective display of vehicle information and an embodiment of an electronic system 100 that is used to implement the method are illustrated.

The electronic system 100 is disposed on a vehicle (not shown). The electronic system 100 includes a plurality of sensing units 1, an output unit 2, an input unit 3 and a processing unit 4 electrically connected to the sensing units 1, the output unit 2 and the input unit 3.

Each of the sensing units 1 detects a physical quantity associated with the vehicle and generating measured data according to a result of detection of the physical quantity. In this embodiment, the measured data generated by each of the sensing units 1 includes numerical data, but is not limited thereto. Each of the sensing units 1 may be a speed sensor for detecting speed of the vehicle, a tire-pressure gauge for measuring pressure of a tire of the vehicle, a tachometer for measuring rotation speed associated with an engine of the vehicle, a thermometer for measuring temperature of the engine of the vehicle or a thermometer for measuring temperature of a car radiator of the vehicle, but is not limited thereto. It should be noted that in some embodiments, each of the sensing units 1 transmits the measured data to the processing unit 4 by wireless communication.

The method includes the following steps S01-S08.

In step S01, the processing unit 4 obtains a plurality of setting instructions which are inputted via the input unit 3, which correspond respectively to the sensing units 1, and each of which includes a predetermined numerical range for the measured data generated by the respective one of the sensing units 1. Each of the plurality of setting instructions further includes a control parameter which corresponds to the respective one of the sensing units 1 and which is referred to for controlling activation or deactivation of display of the measured data generated by the respective one of the sensing units 1. In other words, by inputting via the input unit 3 one of the setting instructions which is used for setting the predetermined numerical range and the control parameter for the corresponding measured data, a user can control the electronic system 100 to display or to hide from display the corresponding measured data according to personal needs or preference. For example, the user can input the setting instruction corresponding to the speed sensor for detecting speed of the vehicle so as to set the predetermined numerical range at over 100 kilometers per hour (km/hr) and to set the control parameter as corresponding to activation of display of the speed of the vehicle, so that display of the measured data is activated and the measured data is displayed on the output unit 2 of the electronic system 100 when the speed of the vehicle falls in the predetermined numerical range, e.g., being greater than 100 km/hr.

However, implementation of the setting instruction may vary in other embodiments. It is worth to note that in some embodiments, the processing unit 4 obtains only one setting instruction which is inputted via the input unit 3, which corresponds to the plurality of sensing units 1, and which includes predetermined numerical ranges corresponding respectively to the measured data generated by the plurality of sensing units 1.

Steps S02 to S08 are performed with respect to each individual sensing unit 1.

In step S02, the processing unit 4 obtains the measured data generated by the sensing unit 1.

In step S03, the processing unit 4 determines for the sensing unit 1, whether the control parameter of the respective one of the setting instructions corresponds to activation of display of the measured data. When it is determined that the control parameter corresponds to activation of display of the measured data, the processing unit 4 performs step S04. Otherwise, when it is determined that the control parameter does not correspond to activation of display of the measured data, the processing unit 4 performs once again steps S02 and S03.

In step S04, the processing unit 4 makes a determination as to whether the measured data satisfies a respective predefined criteria. In this embodiment, the determination is associated with whether the numerical data included in the measured data falls within the respective one of the predetermined numerical ranges, but is not limited thereto. For example, the processing unit 4 determines whether the speed of the vehicle, which is measured by the sensing unit 1 exemplified as the speed sensor, is greater than 100 km/hr. When a result of the determination is affirmative, the processing unit 4 performs step S05 to control the output unit 2 to display the measured data, e.g., 110 km/hr, the speed of the vehicle currently measured. When the result of the determination is negative, the processing unit 4 performs step S08 to control the output unit 2 to refrain from displaying the measured data, and the flow goes back to step S02. Therefore, only the numerical data of the measured data which falls within the predetermined numerical range is displayed, so the limited space of display on the output unit 2 can be utilized more effectively and efficiently for allowing clearer reading of the measured data by the user.

In step S06, the processing unit 4 makes another determination as to whether or not a deactivation command which is inputted via the input unit 3 and which is associated with the measured data (that satisfies the respective predefined criteria and is currently displayed on the output unit 2) has been obtained within a predetermined time period, e.g., within 5 seconds. The deactivation command is used for controlling deactivation of display of the measured data which is currently displayed on the output unit 2. When a result of the another determination made in step S06 is affirmative, the processing unit 4 performs steps S07 and S08 to control the output unit 2 to stop displaying the measured data generated by the sensing unit 1. Otherwise, when the result of the determination made in step S06 is negative, the flow of the method goes back to step S02.

In step S07, based on the deactivation command obtained within the predetermined time period, the processing unit 4 sets the control parameter of the respective setting instruction as corresponding to deactivation of display of the measured data.

In step S08, the processing unit 4 controls the output unit 2 to refrain from displaying the measured data, and the flow goes back to step S02. Therefore, the measured data corresponding to each sensing unit 1 can be refrained from being displayed according to personal preference or needs by setting the control parameter of the respective setting instruction. It is noted that in this embodiment, the control parameters of the setting instructions are stored in a storage unit (not shown) of the electronic system 100 for allowing the processing unit 4 to set these control parameters in step S07.

It is worth noting that, in this embodiment, the electronic system 100 is a smartphone. The output unit 2 is a display of the smartphone. The processing unit 4 is exemplified as a processor or a central processing unit in the smartphone. The input unit 3 includes a touch input device and a sound receiver. In some embodiments, the touch input device and the display may be integrated as a touch screen. The setting instructions obtained in step S01 are inputted via the touch input device of the input unit 3. The deactivation command in step S06 is a voice command inputted via the sound receiver of the input unit 3. The measured data is displayed on the output unit 2 in a way of mirror writing, so that the measured data is able to appear in a natural way on a reflecting surface of the vehicle by projection of the mirror writing of the measured data on the reflecting surface. In this embodiment, the reflecting surface is exemplified as a surface of a windshield of the vehicle or a reflecting surface of a head-up display. The measured data generated by the sensing units 1 are transmitted via a car computer of the vehicle to the processing unit 4 of the electronic system 100, i.e., the smartphone. In addition, the electronic system 100 may be connected to an automotive device, such as a device including an on-board diagnostics II (OBD-II) interface, a navigation device, or a car recorder, and displays information provided by the automotive device.

In summary, the processing unit 4 controls the output unit 2 to display the measured data when it is determined by the processing unit 4 that the numerical data of the measured data falls within the corresponding predetermined numerical range, and controls the output unit 2 to refrain from displaying the measured data when it is determined by the processing unit 4 that the numerical data of the measured data falls outside the corresponding predetermined numerical range. Therefore, only the measured data which is important for the user, i.e., the numerical data of the measured data that falls within the predetermined numerical range, is displayed. Consequently, the user is not distracted by the measured data which is unnecessary and can focus on the measured data which is worth to note, and the limited space of display on the output unit 2 can be utilized more effectively and efficiently. Moreover, the measured data can be selectively displayed according to personal needs or preference via the setting instructions/deactivation commands, and flexibility is thereby enhanced.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method of selective display of vehicle information, the method to be implemented by an electronic system that is disposed on a vehicle and that includes a sensing unit, an output unit and a processing unit, the sensing unit detecting a physical quantity associated with the vehicle and generating measured data according to a result of detection of the physical quantity, the method comprising steps of:
a) obtaining, by the processing unit, the measured data generated by the sensing unit;
b) determining, by the processing unit, whether the measured data satisfies a predefined criteria;
c) controlling, by the processing unit, the output unit to display the measured data when the processing unit determines that the measured data satisfies the predefined criteria; and
d) controlling, by the processing unit, the output unit to refrain from displaying the measured data when the processing unit determines that the measured data does not satisfy the predefined criteria.

2. The method as claimed in claim 1, wherein the measured data includes numerical data, and step b) includes determining whether the numerical data falls within a predetermined numerical range.

3. The method as claimed in claim 2, the electronic system further including an input unit, the method further comprising, prior to step a):
e) obtaining, by the processing unit, a setting instruction corresponding to the sensing unit from the input unit, and the setting instruction includes a predetermined numerical range for the measured data generated by the sensing unit.

4. The method as claimed in claim 3, wherein:
in step e), the setting instruction further includes a control parameter which corresponds to the sensing unit and which is referred to for controlling activation or deactivation of display of the measured data generated by the sensing unit; and
for the setting instruction obtained in step e), step b) includes, when the processing unit determines that the control parameter of the setting instruction corresponds to activation of display of the measured data, the processing unit determines whether the numerical data falls within the predetermined numerical range.

5. The method as claimed in claim 4, subsequent to step c), further comprising:
f) determining, by the processing unit, whether or not a deactivation command is received from the input unit within a predetermined time period, the deactivation command being used for controlling deactivation of display of the measured data generated by the sensing unit and the measured data is currently displayed on the output unit; and
g) controlling, by the processing unit, the output unit to stop displaying the measured data generated by the sensing unit when the processing unit receives the deactivation command from the input unit within the predetermined time period.

6. The method as claimed in claim 5, the input unit including a microphone, wherein in step f), the deactivation command is a voice command inputted via the microphone of the input unit.

7. The method as claimed in claim 1, wherein step c) includes controlling the output unit to display the measured data in a way of mirror writing, so that the measured data appears on a reflected surface of the vehicle by projection of the mirror writing of the measured data on the reflected surface.

8. The method as claimed in claim 1, the sensing unit 1 being plural in number, wherein:
step a) includes obtaining, by the processing unit, the measured data generated by each of the sensing units; and
steps b) to d) are performed with respect to each of the sensing units.

9. The method as claimed in claim 8, the measured data that is generated by each of the sensing units including numerical data,
wherein for the measured data that is generated by each of the sensing units, step b) includes making the determination as to whether the numerical data falls within the predetermined numerical range.

10. The method as claimed in claim 9, the electronic system further including an input unit, the method further comprising, prior to step a):
e) obtaining, by the processing unit, a plurality of setting instructions which are inputted via the input unit, which correspond respectively to the sensing units, and each of which includes a predetermined numerical range for the measured data generated by the respective one of the sensing units.

11. The method as claimed in claim 10, wherein:
in step e), each of the plurality of setting instructions further includes a control parameter which corresponds to the respective one of the sensing units and which is referred to for controlling activation or deactivation of display of the measured data generated by the respective one of the sensing units; and
for each of the setting instructions obtained in step e), step b) includes, when it is determined by the processing unit that the control parameter of the setting instruction corresponds to activation of display of the measured data generated by the respective one of the sensing units, making the determination as to whether the numerical data falls within the predetermined numerical range.

12. The method as claimed in claim 11, subsequent to step c), further comprising:
f) making another determination, by the processing unit, as to whether or not a deactivation command which is associated with the measured data generated by the respective one of the sensing units and which is inputted via the input unit has been obtained within a predetermined time period, the deactivation command being used for controlling deactivation of display of the measured data which is generated by the respective one of the sensing units and which is currently displayed on the output unit; and
g) controlling, by the processing unit when a result of the another determination made in step f) is affirmative, the output unit to stop displaying the measured data generated by the respective one of the sensing units.
